(19) United States
(12) Patent Application Publication
(10) Pub. No.: US 2020/0018534 A1
(43) Pub. Date: Jan. 16, 2020

(54) MOTOR DRIVING DEVICE AND AIR CONDITIONER

(71) Applicant: Mitsubishi Electric Corporation, Tokyo (JP)

(72) Inventors: Atsushi TSUCHIYA, Tokyo (JP); Takashi YAMAKAWA, Tokyo (JP); Kenji IWAZAKI, Tokyo (JP); Keisuke UEMURA, Tokyo (JP); Koichi ARISAWA, Tokyo (JP)

(21) Appl. No.: 16/327,995

(22) PCT Filed: Oct. 31, 2016
(86) PCT No.: PCT/JP2016/082238

§ 371 Date: Feb. 25, 2019

(51) Int. Cl. F25B 49/02; H02P 25/18; H02P 27/06; F25B 31/02; F24F 11/46

(52) U.S. Cl. CPC F25B 49/025; H02P 25/18; F24F 11/46; F25B 31/02; H02P 27/06

(57) ABSTRACT

A motor driving device and an air conditioner are capable of increasing the efficiency in a low speed region in which a motor performs low speed rotation. The motor driving device that is a motor driving device for driving a motor including stator windings, includes: a connection switching unit that switches connection condition of the stator windings to either of first connection condition and second connection condition different from the first connection condition; and an inverter that converts a DC voltage into AC drive voltages and supplies the AC drive voltages to the stator windings. The inverter includes MOS transistors as switching elements.

### CROSS REFERENCE TO RELATED APPLICATION

This application is a U.S. national stage application of International Patent Application No. PCT/JP2016/082238 filed on Oct. 31, 2016, the disclosure of which is incorporated herein by reference.

### TECHNICAL FIELD

The present invention relates to a motor driving device for driving a motor and to an air conditioner including a motor driving device for driving a motor for a compressor.

### BACKGROUND

In general, air conditioners for household use are subject to regulations under energy-saving laws and are commodities obliged to reduce CO₂ emission in terms of global environment. With the advancement of technology, compression efficiency of compressors, operating efficiency of compressor motors, the heat transfer rate of heat exchangers, etc. have been improved, energy consumption efficiency COP (Coefficient Of Performance) of air conditioners has increased year by year, and running costs (power consumption=CO₂ emission) have decreased.

However, the COP is a performance value at one point when the air conditioner is operated under a certain temperature condition, and operating conditions of the air conditioner varying depending on seasons are not taken into account. Nevertheless, capacity and power consumption necessary at the time of cooling/heating vary in actual use due to variations in outside air temperature. Thus, in order to make an evaluation in a condition close to the actual use, APF (Annual Performance Factor), as efficiency obtained by specifying a certain model case and calculating a total load and a total electric energy consumption throughout a year, is currently used as an index of energy saving.

Especially in inverter-type models that are currently mainstream, the capacity changes depending on the revolution speed of the motor of the compressor, and thus there is a problem in making the evaluation close to the actual use by use of rated conditions alone. In the APF of air conditioners for household use, the electric energy consumption corresponding to the total load throughout a year is calculated at five evaluation points of cooling rated, cooling intermediate, heating rated, heating intermediate and heating low temperature. Among these five evaluation points, the cooling rated, the heating rated and the heating low temperature are in a high speed (overload) region in which the motor performs high speed rotation, while the cooling intermediate and the heating intermediate are in a low speed (low load) region in which the motor performs low speed rotation.

As for the contents of the total load throughout a year, the ratio of the heating intermediate condition for performing low speed rotation is extremely high (approximately 50%), and the ratio of the heating rated condition for performing high speed rotation is the second highest (approximately 25%). Accordingly, increasing the efficiency of the motor in the heating intermediate condition for performing low speed rotation is effective for improving energy saving performance of air conditioners.

To improve the energy saving performance of air conditioners, Patent Reference 1 proposes a motor driving device including a connection switching unit that switches stator windings of a motor receiving drive voltage supplied from an inverter between star connection and delta connection.

### PATENT REFERENCE

Patent Reference 1: Japanese Patent Application Publication No. 2006-246674 (claim 1, paragraphs 0016 to 0020 and 0047 to 0048, FIG. 1, FIG. 2 and FIG. 7)

However, since IGBTs (Insulated Gate Bipolar Transistors) are generally used as switching elements of the inverter in conventional technology, conduction loss of the inverter is high in the low speed (low load) region in which the motor performs low speed rotation and efficiency improvement of the motor driving device has not been made sufficiently.

### SUMMARY

It is therefore an object of the present invention to provide a motor driving device and an air conditioner capable of increasing the efficiency in the low speed (low load) region in which the motor performs low speed rotation.

A motor driving device according to an aspect of the present invention that is a motor driving device for driving a motor including stator windings, includes: a connection switching unit that switches connection condition of the stator windings to either of first connection condition and second connection condition different from the first connection condition; and an inverter that includes a plurality of switching elements, converts a DC voltage into AC drive voltages by on/off switching of the plurality of switching elements, and supplies the AC drive voltages to the stator windings, wherein each of the plurality of switching elements includes a MOS transistor.

An air conditioner according to another aspect of the present invention includes a motor including stator windings, a compressor driven by the motor, and the aforementioned motor driving device that drives the motor.

According to the present invention, the efficiency of the motor driving device can be increased in the low speed (low load) region in which the motor performs low speed rotation.

### BRIEF DESCRIPTION OF THE DRAWINGS

FIG. 1 is a diagram schematically showing a configuration of a motor driving device according to a first embodiment of the present invention (in a case of star connection).

FIG. 2 is a diagram schematically showing the configuration of the motor driving device according to the first embodiment (in a case of delta connection).

FIGS. 3(A) and 3(B) are diagrams showing the star connection and the delta connection.

FIG. 4 is a cross-sectional view schematically showing internal structure of a motor shown in FIG. 1 and FIG. 2.

FIGS. 5(A) to 5(C) are diagrams showing U-phase windings connected in series, V-phase windings connected in series, and W-phase windings connected in series.

FIGS. 6(A) to 6(C) are diagrams showing U-phase windings connected in parallel, V-phase windings connected in parallel, and W-phase windings connected in parallel.

FIG. 7 is a graph showing the relationship between revolution speed of the motor and efficiency of the motor in a case where connection condition is the star connection and the delta connection.

FIG. 8 is a graph showing the relationship between the type of switching elements (SiC-MOSFETs or Si-IGBTs) of an inverter in the first embodiment and conduction loss.

FIG. 9 is a block diagram showing a configuration of an air conditioner according to a second embodiment of the present invention.

FIG. 10 is a block diagram showing a control system of the air conditioner according to the second embodiment.

FIG. 11 is a timing chart showing an example of the operation of the air conditioner according to the second embodiment.

### DETAILED DESCRIPTION

### (1) First Embodiment

### (1-1) Configuration of First Embodiment

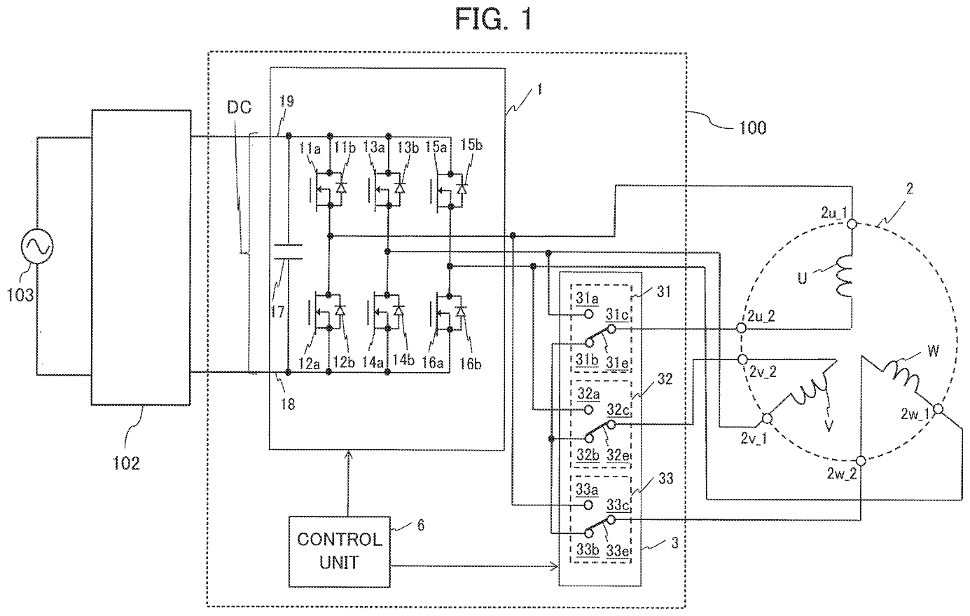

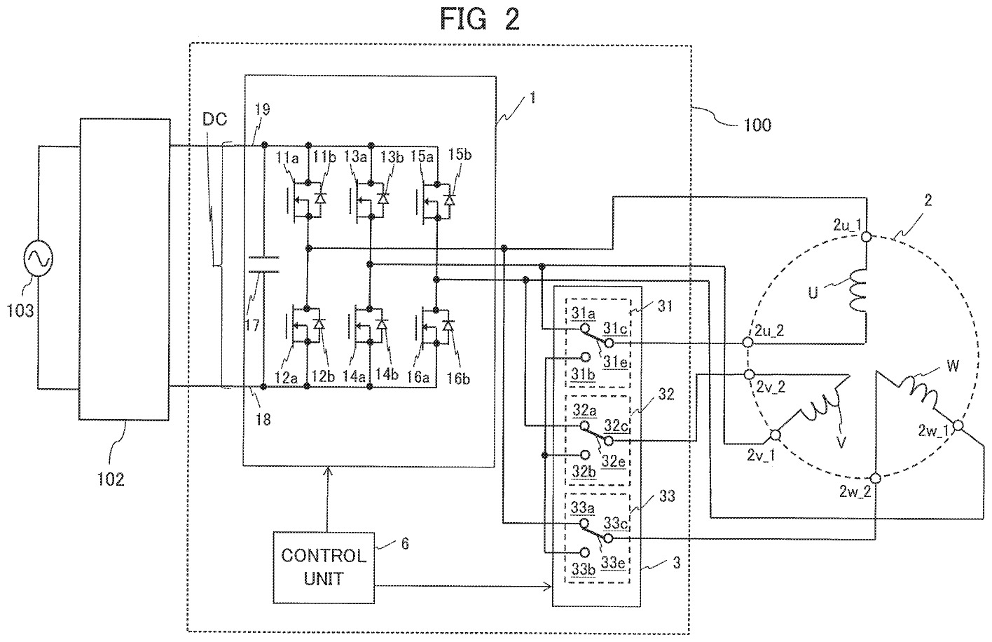

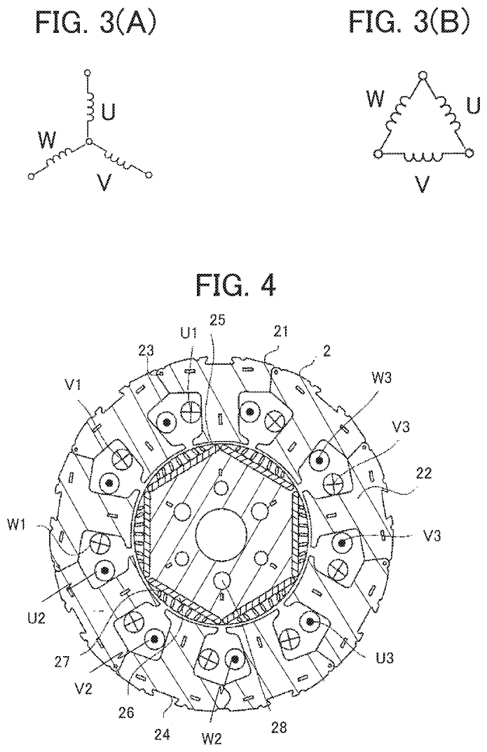

FIG. 1 is a diagram schematically showing a configuration of a motor driving device 100 according to a first embodiment of the present invention (in a case of star connection). FIG. 2 is a diagram schematically showing the configuration of the motor driving device 100 according to the first embodiment (in a case of delta connection). FIGS. 3(A) and 3(B) are diagrams showing the star connection (Y connection) and the delta connection (A connection).

As shown in FIG. 1 and FIG. 2, the motor driving device 100 according to the first embodiment is a device for driving a motor 2 including stator windings of three phases, namely, a U-phase, a V-phase and a W-phase. The motor driving device 100 according to the first embodiment is connected to an AC power supply 103 and a converter 102 that converts AC voltage supplied from the AC power supply 103 into a DC voltage. Incidentally, while the illustrated example shows a case where the motor driving device 100 does not include the converter 102, the motor driving device 100 may also include the converter 102.

The motor driving device 100 according to the first embodiment includes an inverter 1 that converts the DC voltage into AC drive voltages to be supplied to an open winding (first open winding) U, an open winding (second open winding) V and an open winding (third open winding) W as the stator windings, a connection switching unit 3 that switches connection condition of the open winding U, the open winding V and the open winding W to either of first connection condition and second connection condition different from the first connection condition, and a control unit 6 that controls the inverter 1 and the connection switching unit 3.

In the first embodiment, the first connection condition is condition of the star connection (FIG. 3(A)) in which neutral points are connected together by the connection switching unit 3, and the second connection condition is condition of the delta connection (FIG. 3(B)). However, the number of phases of the stator windings of the motor 2 is not limited to three but can also be two or four or more.

The open winding U includes a winding terminal (first winding terminal) 2u_1 connected to a U-phase output terminal of the inverter 1 and a winding terminal (second winding terminal) 2u_2 connected to the connection switching unit 3. The open winding V includes a winding terminal (third winding terminal) 2v_1 connected to a V-phase output terminal of the inverter 1 and a winding terminal (fourth winding terminal) 2v_2 connected to the connection switching unit 3. The open winding W includes a winding terminal (fifth winding terminal) 2w_1 connected to a W-phase output terminal of the inverter 1 and a winding terminal (sixth winding terminal) 2w_2 connected to the connection switching unit 3.

As shown in FIG. 1 and FIG. 2, the inverter 1 includes MOS transistors (MOSFETs: Metal-Oxide-Semiconductor Field-Effect Transistors) 11a and 12a as switches (a plurality of switching elements) connected in series between electric power supply lines 18 and 19 to which the DC voltage is supplied, MOS transistors 13a and 14a as switches connected in series between the electric power supply lines 18 and 19, MOS transistors 15a and 16a as switches connected in series between the electric power supply lines 18 and 19, and a capacitor 17 connected between the electric power supply lines 18 and 19.

In the inverter 1, the MOS transistors 11a, 13a and 15a are upper arms, while the MOS transistors 12a, 14a and 16a are lower arms. The electric power supply lines 18 and 19 are busses supplied with the DC voltage outputted from the converter 102 converting the AC voltage into the DC voltage. The U-phase output terminal of the inverter 1 is connected to a node (intermediate point) between the MOS transistors 11a and 12a, the V-phase output terminal of the inverter 1 is connected to a node (intermediate point) between the MOS transistors 13a and 14a, and the W-phase output terminal of the inverter 1 is connected to a node (intermediate point) between the MOS transistors 15a and 16a.

Each MOS transistor 11a, 12a, 13a, 14a, 15a, 16a is turned on (conduction between the source and the drain) or off (non-conduction between the source and the drain) according to an inverter drive signal outputted from the control unit 6, that is, a gate control signal for the MOS transistor. The inverter 1 further includes parasitic diodes 11b, 12b, 13b, 14b, 15b and 16b as diodes connected in parallel with the MOS transistors 11a, 12a, 13a, 14a, 15a and 16a respectively. However, the configuration of the inverter 1 is not limited to the configuration shown in FIG. 1 and FIG. 2.

As shown in FIG. 1 and FIG. 2, the connection switching unit 3 includes mechanical switches, namely, a relay (first relay) 31, a relay (second relay) 32 and a relay (third relay) 33. The number of relays of the connection switching unit 3 is greater than or equal to the number of phases of the open windings of the stator windings.

The relay 31 has a first terminal (contact point) 31a connected to the V-phase output terminal of the inverter 1, a second terminal (contact point) 31b connected to a fifth terminal 32b of a switch circuit 32 and an eighth terminal 33b of a switch circuit 33 which will be described later, and a third terminal 31c connected to the winding terminal 2u_2 of the open winding U and electrically connected to one of the first terminal 31a and the second terminal 31b via a switch movable part 31e.

The relay 32 has a fourth terminal (contact point) 32a connected to the W-phase output terminal of the inverter 1, the fifth terminal (contact point) 32b connected to the second terminal 31b of the relay 31 and the eighth terminal 33b of the switch circuit 33, and a sixth terminal 32c connected to the winding terminal 2v_2 of the open winding V and electrically connected to one of the fourth terminal 32a and the fifth terminal 32b via a switch movable part 32e.

The relay 33 has a seventh terminal (contact point) 33a connected to the U-phase output terminal of the inverter 1, the eighth terminal (contact point) 33b connected to the second terminal 31b of the relay 31 and the fifth terminal 32b of the relay 32, and a ninth terminal 33c connected to the winding terminal 2w_2 of the open winding W and electrically connected to one of the seventh terminal 33a and the eighth terminal 33b via a switch movable part 33e.

In the connection switching unit 3, the closing (conduction, namely, connection) and the opening (non-conduction, namely, disconnection) between terminals of the relays as the mechanical switches are controlled according to a connection switching signal outputted from the control unit 6. The connection switching unit 3 switches the connection condition of the stator windings of the motor 2 to the star connection (FIG. 3(A)), as the first connection condition in which the neutral points are connected together by the connection switching unit 3, by connecting the second terminal 31b and the third terminal 31c together via the switch movable part 31e in the relay 31, connecting the fifth terminal 32b and the sixth terminal 32c together via the switch movable part 32e in the relay 32, and connecting the eighth terminal 33b and the ninth terminal 33c together via the switch movable part 33e in the relay 33.

Further, the connection switching unit 3 switches the connection condition to the delta connection (FIG. 3(B)) as the second connection condition by connecting the first terminal 31a and the third terminal 31c together via the switch movable part 31e in the relay 31, connecting the fourth terminal 32a and the sixth terminal 32c together via the switch movable part 32e in the relay 32, and connecting the seventh terminal 33a and the ninth terminal 33c together via the switch movable part 33e in the relay 33. Incidentally, while the relays 31, 32 and 33 are shown in FIG. 1 and FIG. 2 as components independent of each other, the relays 31, 32 and 33 may also be implemented as one relay that concurrently operates the three switch movable parts 31e, 32e and 33e.

The operation of the inverter 1 in the case shown in FIG. 1 where the connection condition is the star connection will be described below. In the case where the connection condition is the star connection, when the MOS transistors 11a, 14a and 16a are ON and the MOS transistors 12a, 13a and 15a are OFF in the inverter 1, the drive current for the motor 2 flows through a path from the MOS transistor 11a successively to the first winding terminal 2u_1, the second winding terminal 2u_2, the third terminal 31c of the first switch circuit 31, the second terminal 31b of the first switch circuit 31, and the neutral point of the star connection.

In a path from the neutral point to pass through the second switch circuit 32, the drive current for the motor 2 flows through a path successively to the fifth terminal 32b of the second switch circuit 32, the sixth terminal 32c of the second switch circuit 32, the fourth winding terminal 2v_2, the third winding terminal 2v_1, the node between the MOS transistors 13a and 14a, and the MOS transistor 14a. In a path from the neutral point to pass through the third switch circuit 33, the drive current for the motor 2 flows through a path successively to the eighth terminal 33b of the third switch circuit 33, the ninth terminal 33c of the third switch circuit 33, the sixth winding terminal 2w_2, the fifth winding terminal 2w_1, the neutral point between the MOS transistor 15a and the MOS transistor 16a, and the MOS transistor 16a.

The operation of the inverter 1 in the case shown in FIG. 2 where the connection condition is the delta connection will be described below. In the case where the connection condition is the delta connection, when the MOS transistors 11a and 14a and 16a are ON and the MOS transistors 12a, 13a, 15a and 16a are OFF in the inverter 1, the drive current for the motor 2 flows through a path from the MOS transistor 11a successively to the first winding terminal 2u_1, the first winding U, the second winding terminal 2u_2, the third terminal 31c of the first switch circuit 31, the first terminal 31a of the first switch circuit 31, and the node between the MOS transistors 13a and 14a.

Thereafter, when the MOS transistor 11a is turned off, the drive current for the motor 2 flows through a path from the third winding terminal 2v_1 successively to the node between the MOS transistors 13a and 14a, the MOS transistor 14a, the MOS transistor 12a, the node between the MOS transistors 11a and 12a, and the first winding terminal 2u_1.

FIG. 4 is a cross-sectional view schematically showing internal structure of the motor 2 shown in FIG. 1 and FIG. 2. As shown in FIG. 4, the motor 2 is a permanent magnet motor in which permanent magnets 26 are embedded in a rotor 25. The motor 2 includes a stator 21 and the rotor 25 arranged in a space on a central side of the stator 21 and supported to be rotatable around a shaft. An air gap is secured between an outer circumferential surface of the rotor 25 and an inner circumferential surface of the stator 21. The air gap between the stator 21 and the rotor 25 is a clearance of approximately 0.3 mm to 1 mm.

Specifically, the rotor 25 is rotated by energizing the stator windings with electric current in sync with a command revolution speed by use of the inverter 1 and generating a rotating magnetic field. Windings U1 to U3, windings V1 to V3, and windings W1 to W3 are wound around tooth parts 22 of the stator 21 via insulating material by means of concentrated winding. The windings U1 to U3 correspond to the open winding U in FIG. 1, the windings V1 to V3 correspond to the open winding V in FIG. 1, and the windings W1 to W3 correspond to the open winding W in FIG. 1.

The stator 21 shown in FIG. 4 is formed of a plurality of split cores arranged in a ring-like shape around a rotation axis 23 when adjacent split cores are connected together, and the split cores arranged in a ring-like shape (a state in which the split cores are closed) can be turned into the split cores arranged in a straight line (a state in which the split cores are open) by opening the tooth parts 22 adjacently arranged. With this configuration, the winding process can be performed in a state in which the split cores are arranged in a straight line and the tooth parts 22 have wide spaces between each other, by which the winding process can be simplified and winding quality can be improved (e.g., occupancy ratio can be increased).

As the permanent magnets 26 embedded in the rotor 25, rare-earth magnets or ferrite magnets are employed, for example. Slits 27 are arranged in outer circumferential core parts of the permanent magnets 26. The slits 27 have a function of lessening the influence of armature reaction caused by the electric current of the stator windings and reducing the superimposition of harmonics on the magnetic flux distribution. Further, the core of the stator 21 and the core of the rotor 25 are provided with air vents 24 and 28. The air vents 24 and 28 have a function of cooling down the motor 2 while serving as refrigerant gas channels or oil return channels.

The motor 2 shown in FIG. 4 has structure of concentrated winding in which the ratio between the number of magnetic poles and the number of slots is 2:3. The motor 2 includes the rotor having permanent magnets for six poles and the stator 21 having nine slots (nine tooth parts). Thus, the motor 2, being a six-pole motor having six permanent magnets, employs structure having windings on three tooth parts (three slots) per phase.

In a case of a four-pole motor, the number of tooth parts (the number of slots) is six and it is desirable to employ structure having windings on two tooth parts per phase. In a case of an eight-pole motor, the number of tooth parts is twelve and it is desirable to employ structure having windings on four tooth parts per phase.

When three-phase windings are used in the delta connection, there are cases where circulating current flows in the windings of the motor 2 and deteriorates the performance of the motor 2. The circulating current flows due to the third harmonic of inductive voltage in the winding of each phase, and in the case of the concentrated winding in which the ratio between the number of magnetic poles and the number of slots is 2:3, no third harmonic occurs in the inductive voltage due to phase relationship between the windings and the permanent magnets as long as there is no influence of magnetic saturation or the like.

In the first embodiment, the motor 2 is configured with the concentrated winding in which the ratio between the number of magnetic poles and the number of slots is 2:3 in order to inhibit the circulating current in use of the motor 2 in delta connection. However, the number of magnetic poles, the number of slots, and the winding method (concentrated winding, distributed winding) may be properly selected depending on required motor size, characteristics (revolution speed, torque, etc.), voltage specifications, cross-sectional area of the slots, and so forth. Further, the structure of the motor to which the present invention is applicable is not limited to that shown in FIG. 4.

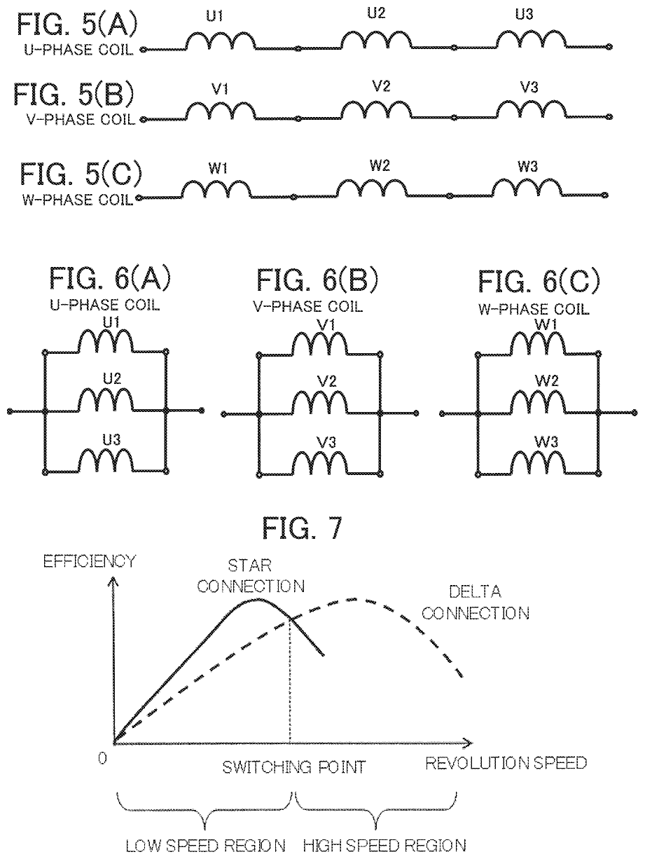

FIGS. 5(A) to 5(C) show an example of the windings shown in FIG. 3, namely, the windings U1, U2 and U3 connected in series, the windings V1, V2 and V3 connected in series, and the windings W1, W2 and W3 connected in series. FIGS. 6(A) to 6(C) show another example of the windings shown in FIG. 3, namely, the windings U1, U2 and U3 connected in parallel, the windings V1, V2 and V3 connected in parallel, and the windings W1, W2 and W3 connected in parallel.

FIG. 7 is a graph showing the relationship between the revolution speed of the motor 2 and the efficiency of the motor 2 in a case where the connection condition is the star connection and the delta connection. The horizontal axis of FIG. 7 represents the revolution speed of the motor 2 and the vertical axis of FIG. 7 represents the efficiency of the motor 2 (ratio of mechanical output power to input electric power). As shown in FIG. 7, the efficiency of the motor 2 in the case where the connection condition is the star connection is excellent in a low speed (low load) region in which the revolution speed of the motor 2 is low, but drops in a high speed (overload) region in which the revolution speed of the motor 2 is high.

The efficiency of the motor 2 in the case where the connection condition is the delta connection is inferior to that in the case of the star connection in the low speed (low load) region, but increases in the high speed (overload) region. Thus, the star connection excels in the efficiency in the low speed (low load) region, while the delta connection excels in the efficiency in the high speed (overload) region. Accordingly, it is desirable to switch from the star connection to the delta connection at the switching point shown in FIG. 7.

Here, the revolution speed of a motor of a compressor under an evaluation load condition of the aforementioned APF varies depending on the capacity of the air conditioner and the performance of the heat exchanger. For example, in a motor of a compressor installed in a home air conditioner having a refrigeration capacity of 6.3 kW, the revolution speed is approximately 35 rps (rotations per second) in a heating intermediate condition for performing low speed rotation, and is approximately 85 rps in a heating rated condition for performing high speed rotation. Thus, in the home air conditioner having the 6.3 kW refrigeration capacity, the aforementioned switching point is desired to be set in the vicinity of 60 rps as a first threshold value between the revolution speeds in the heating intermediate condition and the revolution speeds in the heating rated condition.

In contrast, it is also possible to switch between the star connection and the delta connection not depending on the revolution speed of the motor 2 but depending on a modulation factor as the ratio of the AC drive voltage supplied to the stator windings to the DC voltage inputted to the inverter 1. In this case, the connection condition is controlled to switch to the star connection when the modulation factor is less than a second threshold value and switch to the delta connection when the modulation factor is higher than or equal to the second threshold value, for example.

By setting the connection condition of the stator windings of the motor 2 in the star connection in the low speed (low load) region as above, the inductive voltage (between lines) can be increased to approximately 1.73 times that in the case of delta connection. With this setting, iron loss of the motor 2 due to harmonics can be reduced and the efficiency of the motor driving device 100 can be increased.

Further, by setting the connection condition of the stator windings of the motor 2 in the delta connection in the high speed (overload) region, it becomes possible to inhibit an excessive increase in copper loss due to field-weakening operation. Furthermore, by setting the connection condition of the stator windings of the motor 2 in the delta connection in the high speed (overload) region, the inductive voltage (between lines) can be decreased to 1/1.73 times that in the case of star connection.

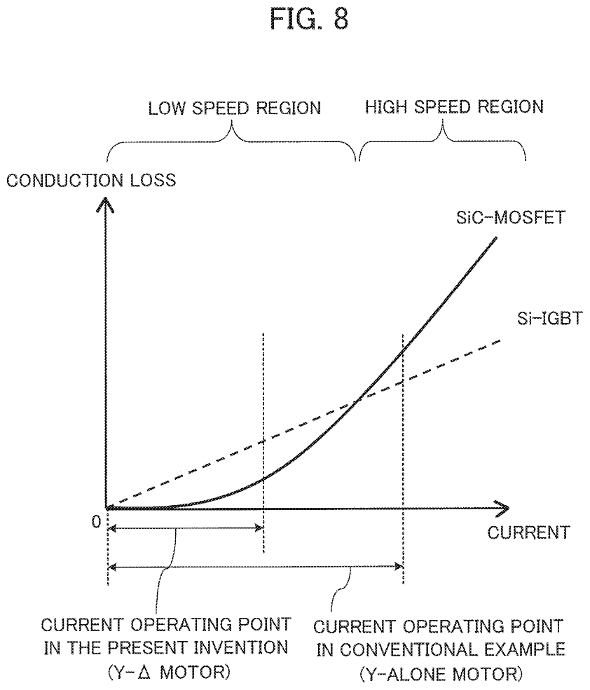

FIG. 8 is a graph showing the relationship between the type of the switching elements (SiC-MOSFETs or Si-IGBTs) of the inverter 1 in the first embodiment and conduction loss. FIG. 8 shows the conduction loss in a case where SiC-MOSFETs (Silicon Carbide Metal-Oxide Semiconductor Field Effect Transistors) and Si-IGBTs (Silicon Insulated Gate Bipolar Transistors) are used as the switching elements of the inverter 1. The horizontal axis of FIG. 8 represents electric current flowing into the inverter 1 and the vertical axis of FIG. 8 represents the conduction loss of the inverter 1.

As shown in FIG. 8, in the low speed (low load) region, the conduction loss is lower when SiC-MOSFETs are used as the switching elements of the inverter 1. In contrast, in the high speed (overload) region, the conduction loss is higher when SiC-MOSFETs are used as the switching elements of the inverter 1. Thus, with the configuration using MOS transistors (e.g., SiC-MOSFETs) as the switching elements of the inverter 1, the conduction loss in the low speed (low load) region can be reduced compared with the configuration using IGBTs as the switching elements of the inverter 1.

FIG. 8 also shows a range of a current operating point of the motor driving device 100 according to the embodiment and a range of the current operating point of a conventional motor having the star connection alone. The motor driving device 100 according to the embodiment is capable of increasing the inductive voltage constant to 1.73 times compared with the conventional motor having the star connection alone by making the switching between the star connection and the delta connection.

Accordingly, the current operating points in FIG. 8 are limited to a narrower range, and thus a range in which MOSFETs are of lower loss than IGBTs can be used, by which the loss can be reduced further compared with the conventional motor. Further, an advantage is obtained in that MOSFETs remain being of lower loss than IGBTs until the current operating point rises to a current value equivalent to the conventional current value, namely, up to a region in which the load is higher than the conventional load.

As the material of the switching elements or diode elements of the inverter 1, it is desirable to use a wide band gap semiconductor such as silicon carbide (SiC), gallium nitride (GaN)-based material or diamond, for example.

Such switching elements or diode elements formed with a wide band gap semiconductor are high in withstand voltage and also high in allowable current density, and thus downsizing of the switching elements or diode elements is possible and the use of the downsized switching elements or diode elements makes it possible to downsize a semiconductor module equipped with these elements. Incidentally, the material of the switching elements or diode elements of the inverter 1 is not limited to wide band gap semiconductors.

Further, by using silicon carbide (SiC) as the material of the switching elements, high-speed switching of the inverter 1 becomes possible and the switching frequency of the inverter 1 can be increased. By increasing the switching frequency of the inverter 1, ripples in the drive current for the motor 2 (current ripples) can be reduced. Accordingly, the harmonic iron loss can be reduced and the efficiency of the motor driving device 100 can be increased.

On the other hand, with the increase in the switching frequency of the inverter 1, switching loss of the inverter 1 generally increases. However, since silicon carbide (SiC) is capable of greatly reducing the switching loss compared with silicon (Si), the reduction in the switching loss can be made for an amount greater than the increase in the switching loss caused by the increase in the switching frequency.

Furthermore, in the motor driving device 100 according to the first embodiment, in addition to the use of MOS transistors as the switching elements of the inverter 1, the stator windings of the motor 2 are switched by the star-delta connection switching method. While the number of turns of the stator windings of the motor 2 is determined generally based on drive characteristics on a high speed side, it is possible to determine the number of turns of the stator windings of the motor 2 based on the drive characteristics in a low speed region in a case where the switching is made by the star-delta connection switching method.

Thus, by switching the stator windings of the motor 2 by the star-delta connection switching method in addition to using MOS transistors capable of improving the drive characteristics in the low speed region as the switching elements, the number of turns of the stator windings of the motor 2 can be increased.

With these features, the inductance value of the motor 2 can be raised and the ripples in the drive current for the motor 2 can be reduced by the filtering effect of the inductance. Accordingly, the harmonic iron loss can be reduced and the efficiency of the motor driving device 100 can be increased.

### (1-2) Effect of First Embodiment

In the motor driving device 100 according to the first embodiment, by using MOS transistors as the switching elements of the inverter 1, the conduction loss of the inverter 1 in the low speed (low load) region can be reduced compared with the case of using IGBTs as the switching elements. Accordingly, the efficiency of the motor driving device 100 in the low speed (low load) region can be increased.

In the motor driving device 100 according to the first embodiment, by using a wide band gap semiconductor as the material of the switching elements of the inverter 1 and using silicon carbide (SiC) as the wide band gap semiconductor, high-speed switching of the inverter 1 becomes possible and the switching frequency of the inverter 1 can be increased. By increasing the switching frequency of the inverter 1, the ripples in the drive current for the motor 2 (current ripples) can be reduced. Accordingly, the harmonic iron loss can be reduced and the efficiency of the motor driving device 100 can be increased.

In the motor driving device 100 according to the first embodiment, the connection switching of the stator windings of the motor 2 is made by the star-delta connection switching method. By making the connection switching of the stator windings of the motor 2 by the star-delta connection switching method in addition to using MOS transistors as the switching elements of the inverter 1, the number of turns of the stator windings of the motor 2 can be determined based on the drive characteristics in the low speed region, and thus the number of turns of the stator windings of the motor 2 can be increased and the inductance value of the motor 2 can be raised. Accordingly, the ripples in the drive current for the motor 2 can be reduced, the harmonic iron loss can be reduced, and the efficiency of the motor driving device 100 can be increased.

In the motor driving device 100 according to the first embodiment, by setting the connection condition of the stator windings of the motor 2 in the star connection in the low speed (low load) region, the inductive voltage (between lines) can be increased to approximately 1.73 times that in the case of delta connection. With this setting, the iron loss of the motor 2 due to harmonics can be reduced and the efficiency of the motor driving device 100 can be increased.

In the motor driving device 100 according to the first embodiment, by setting the connection condition of the stator windings of the motor 2 in the delta connection in the high speed (overload) region, it becomes possible to inhibit the excessive increase in the copper loss due to the field-weakening operation. Further, by setting the connection condition of the stator windings of the motor 2 in the delta connection in the high speed (overload) region, the inductive voltage (between lines) can be decreased to 1/1.73 times that in the case of star connection.

In the motor driving device 100 according to the first embodiment, the connection condition is switched from the star connection to the delta connection in the high speed region. Since the delta connection decreases the inductive voltage to 1/1.73 times compared with the star connection, even if the inductive voltage constant is increased to 1.73 times compared with a motor of the star connection, the switching to the delta connection in the high speed region allows the voltage usage ratio to remain at the same value as long as the load condition is the same. Thus, the inductive voltage constant can be increased to 1.73 times compared with the conventional motor having the star connection alone. Accordingly, in the low speed region and the high speed region, the motor current can be reduced and the driving with higher efficiency is possible compared with the conventional motor having the star connection alone.

In the motor driving device 100 according to the first embodiment, the inductive voltage constant can be increased to 1.73 times compared with the conventional motor having the star connection alone by making the switching between the star connection and the delta connection. Accordingly, the current operating points in FIG. 8 are limited to a narrower range, and thus a range in which MOSFETs are of lower loss than IGBTs can be used, by which the loss can be reduced further compared with the conventional motor. Further, an advantage is obtained in that MOSFETs remain being of lower loss than IGBTs until the current operating point rises to a current value equivalent to the conventional current value, namely, up to a region in which the load is higher than the conventional load.

### (2) Second Embodiment

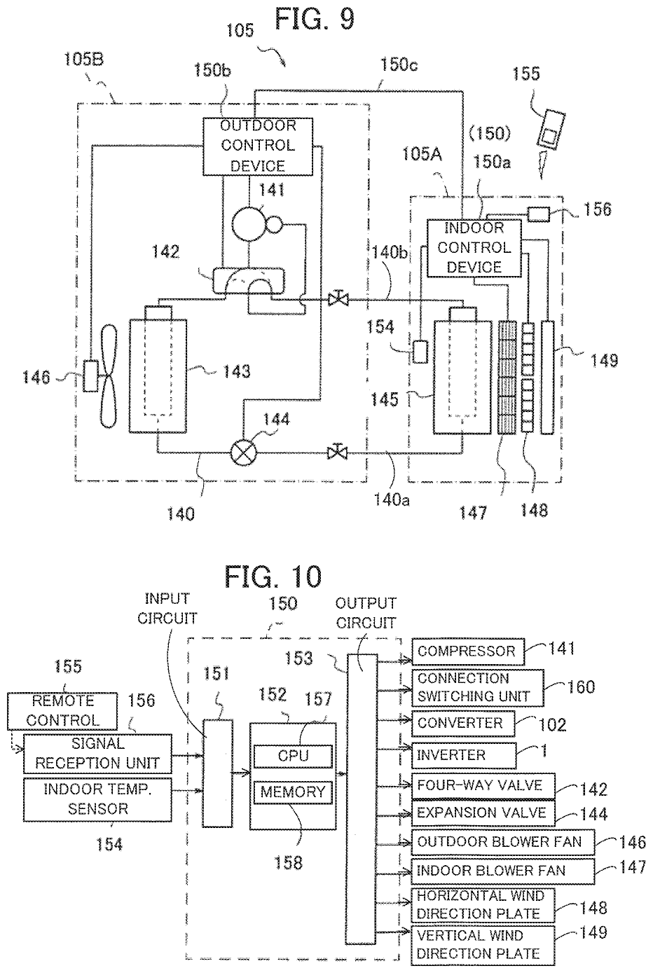

An air conditioner 105 including the motor driving device 100 according to the first embodiment will be described below. FIG. 9 is a block diagram showing a configuration of the air conditioner 105 according to a second embodiment of the present invention. The air conditioner 105 includes an indoor unit 105A that is installed in a room (in a cooling/heating object space) and an outdoor unit 105B that is installed outdoors. The indoor unit 105A and the outdoor unit 105B are connected together by connection pipings 140a and 140b in which a refrigerant flows. In the connection piping 140a, a liquid refrigerant after passing through a condenser flows. In the connection piping 140b, a gas refrigerant after passing through an evaporator flows.

The outdoor unit 105B includes a compressor 141 that compresses the refrigerant and discharges the compressed refrigerant, a four-way valve (refrigerant channel selector valve) 142 that switches the flow direction of the refrigerant, an outdoor heat exchanger 143 that performs heat exchange between outside air and the refrigerant, and an expansion valve (decompression device) 144 that decompresses the high-pressure refrigerant into low pressure. The compressor 141 is formed with a rotary compressor, for example. The indoor unit 105A includes an indoor heat exchanger 145 that performs heat exchange between indoor air and the refrigerant.

The compressor 141, the four-way valve 142, the outdoor heat exchanger 143, the expansion valve 144 and the indoor heat exchanger 145 are connected together by piping 140 including the connection pipings 140a and 140b to form a refrigerant circuit. With these components, a compression refrigeration cycle (compression heat pump cycle) circulating the refrigerant with the compressor 141 is formed.

To control the operation of the air conditioner 105, an indoor control device 150a is arranged in the indoor unit 105A and an outdoor control device 150b is arranged in the outdoor unit 105B. Each of the indoor control device 150a and the outdoor control device 150b includes a control board on which various circuits for controlling the air conditioner 105 have been formed. The indoor control device 150a and the outdoor control device 150b are connected to each other by a communication cable 150c.

In the outdoor unit 105B, an outdoor blower fan 146 as a blower is arranged to face the outdoor heat exchanger 143. The outdoor blower fan 146 rotates and thereby generates an air flow passing through the outdoor heat exchanger 143. The outdoor blower fan 146 is formed with a propeller fan, for example. The outdoor blower fan 146 is arranged on a downstream side of the outdoor heat exchanger 143 in its air blow direction (direction of the air flow).

The four-way valve 142 is controlled by the outdoor control device 150b and switches the direction in which the refrigerant flows. When the four-way valve 142 is at the position indicated by the solid line in FIG. 9, the gas refrigerant discharged from the compressor 141 is sent to the outdoor heat exchanger (condenser) 143. In contrast, when the four-way valve 142 is at the position indicated by the broken line in FIG. 9, the gas refrigerant flowing in from the outdoor heat exchanger (evaporator) 143 is sent to the compressor 141. The expansion valve 144 is controlled by the outdoor control device 150b and decompresses the high-pressure refrigerant into low pressure by changing its opening degree.

In the indoor unit 105A, an indoor blower fan 147 as a blower is arranged to face the indoor heat exchanger 145. The indoor blower fan 147 rotates and thereby generates an air flow passing through the indoor heat exchanger 145. The indoor blower fan 147 is formed with a cross flow fan, for example. The indoor blower fan 147 is arranged on the downstream side of the indoor heat exchanger 145 in its air blow direction.

The indoor unit 105A is provided with an indoor temperature sensor 154 as a temperature sensor that measures indoor temperature Ta as air temperature in the room (temperature of the cooling/heating object) and sends temperature information (information signal) obtained by the measurement to the indoor control device 150a. The indoor temperature sensor 154 may be formed with a temperature sensor used for standard air conditioners, or it is also possible to use a radiation temperature sensor that detects surface temperature of a wall, floor or the like in the room.

The indoor unit 105A is further provided with a signal reception unit 156 that receives a command signal transmitted from a user operation unit operated by the user such as a remote control 155. With the remote control 155, the user makes operation inputs (operation start and stoppage) or issues commands in regard to the operation (set temperature, wind speed, etc.) to the air conditioner 105.

The compressor 141 is driven by the motor 2 described in the first embodiment. The motor 2 is generally formed integrally with a compression mechanism of the compressor 141. The compressor 141 is configured to be able to vary the operating revolution speed in a range of 20 rps to 120 rps in normal operation.

With the increase in the revolution speed of the compressor 141, refrigerant circulation volume of the refrigerant circuit increases. The revolution speed of the compressor 141 is controlled by the outdoor control device 150b based on temperature difference ΔT between the present indoor temperature Ta obtained by the indoor temperature sensor 154 and the set temperature Ts set by the user through the remote control 155. With the increase in the temperature difference ΔT, the compressor 141 rotates at higher speed and increases the circulation volume of the refrigerant.

The rotation of the indoor blower fan 147 is controlled by the indoor control device 150a. The revolution speed of the indoor blower fan 147 can be switched in multiple steps (e.g., three steps of “strong wind”, “middle wind” and “low wind”). When the wind speed setting has been set at an automatic mode by using the remote control 155, the revolution speed of the indoor blower fan 147 is switched based on the temperature difference ΔT between the measured indoor temperature Ta and the set temperature Ts.

The rotation of the outdoor blower fan 146 is controlled by the outdoor control device 150b. The revolution speed of the outdoor blower fan 146 can be switched in multiple steps. For example, the revolution speed of the outdoor blower fan 146 is switched based on the temperature difference ΔT between the measured indoor temperature Ta and the set temperature Ts. The indoor unit 105A further includes a horizontal wind direction plate 148 and a vertical wind direction plate 149.

The basic operation of the air conditioner 105 is as follows: In the cooling operation, the four-way valve 142 is switched to the position indicated by the solid line and the high-temperature and high-pressure gas refrigerant discharged from the compressor 141 flows into the outdoor heat exchanger 143. In this case, the outdoor heat exchanger 143 operates as a condenser. When air passes through the outdoor heat exchanger 143 due to the rotation of the outdoor blower fan 146, the air absorbs condensation heat of the refrigerant by means of heat exchange. The refrigerant is condensed into a high-pressure and low-temperature liquid refrigerant and then adiabatically expanded by the expansion valve 144 into a low-pressure and low-temperature two-phase refrigerant.

The refrigerant that passed through the expansion valve 144 flows into the indoor heat exchanger 145 of the indoor unit 105A. The indoor heat exchanger 145 operates as an evaporator. When air passes through the indoor heat exchanger 145 due to the rotation of the indoor blower fan 147, the refrigerant absorbs evaporation heat and evaporates by means of heat exchange, and the air cooled down by the heat exchange is supplied to the inside of the room. The refrigerant evaporates into a low-temperature and low-pressure gas refrigerant and then compressed again by the compressor 141 into the high-temperature and high-pressure refrigerant.

In the heating operation, the four-way valve 142 is switched to the position indicated by the dotted line and the high-temperature and high-pressure gas refrigerant discharged from the compressor 141 flows into the indoor heat exchanger 145. In this case, the indoor heat exchanger 145 operates as a condenser. When air passes through the indoor heat exchanger 145 due to the rotation of the indoor blower fan 147, the air absorbs condensation heat of the refrigerant by means of heat exchange. By this operation, the heated air is supplied to the inside of the room. The refrigerant is condensed into a high-pressure and low-temperature liquid refrigerant and then adiabatically expanded by the expansion valve 144 into a low-pressure and low-temperature two-phase refrigerant.

The refrigerant that passed through the expansion valve 144 flows into the outdoor heat exchanger 143 of the outdoor unit 105B. The outdoor heat exchanger 143 operates as an evaporator. When air passes through the outdoor heat exchanger 143 due to the rotation of the outdoor blower fan 146, the refrigerant absorbs evaporation heat and evaporates by means of heat exchange. The refrigerant evaporates into a low-temperature and low-pressure gas refrigerant and is then compressed again by the compressor 141 into the high-temperature and high-pressure refrigerant.

The indoor control device 150a and the outdoor control device 150b control the air conditioner 105 while exchanging information with each other via the communication cable 150c. The indoor control device 150a and the outdoor control device 150b will hereinafter be referred to collectively as a control device 150. The control device 150 corresponds to the control unit 6 in the first embodiment.

FIG. 10 is a block diagram showing a control system of the air conditioner 105. The control device 150 is formed with a microcomputer, for example. An input circuit 151, an arithmetic circuit 152 and an output circuit 153 have been installed in the control device 150.

To the input circuit 151, the command signal received by the signal reception unit 156 from the remote control 155 is inputted. The command signal includes a signal for setting an operation input, an operation mode, the set temperature, an air flow rate or a wind direction, for example. The temperature information indicating the indoor temperature detected by the indoor temperature sensor 154 is also inputted to the input circuit 151. The input circuit 151 outputs these pieces of input information to the arithmetic circuit 152.

The arithmetic circuit 152 includes a CPU (Central Processing Unit) 157 and a memory 158. The CPU 157 performs arithmetic processing and judgment processing. The memory 158 stores various types of set values and programs to be used for the control of the air conditioner 105. The arithmetic circuit 152 performs computation and judgment based on the information inputted from the input circuit 151 and outputs the result to the output circuit 153.

The output circuit 153 outputs control signals to the compressor 141, a connection switching unit 160, the converter 102, the inverter 1, the four-way valve 142, the expansion valve 144, the outdoor blower fan 146, the indoor blower fan 147, the horizontal wind direction plate 148 and the vertical wind direction plate 149 based on the information inputted from the arithmetic circuit 152. The connection switching unit 160 is the connection switching unit 3 in the first embodiment.

The control device 150 controls various types of devices in the indoor unit 105A and the outdoor unit 105B. Actually, each of the indoor control device 150a and the outdoor control device 150b is formed with a microcomputer. Incidentally, it is also possible to install the control device in only one of the indoor unit 105A and the outdoor unit 105B to control the various types of devices in the indoor unit 105A and the outdoor unit 105B.

The arithmetic circuit 152 analyzes the command signal inputted from the remote control 155 via the input circuit 151 and figures out, for example, the operation mode and the temperature difference ΔT between the set temperature Ts and the indoor temperature Ta based on the result of the analysis. When the operation mode is the cooling operation, the temperature difference ΔT is calculated as ΔT=Ta−Ts. When the operation mode is the heating operation, the temperature difference ΔT is calculated as ΔT=Ts−Ta.

The arithmetic circuit 152 controls the motor driving device 100 based on the temperature difference ΔT and thereby controls the revolution speed of the motor 2 (namely, the revolution speed of the compressor 141).

The basic operation of the air conditioner 105 is as described below. When the operation is started, the control device 150 starts up in the delta connection that is the connection at the end of the previous operation. The control device 150 drives fan motors of the indoor blower fan 147 and the outdoor blower fan 146 as a startup process of the air conditioner 105.

Subsequently, the control device 150 outputs a voltage switching signal to the converter 102 supplying the DC voltage (bus voltage) to the inverter 1 and thereby raises the bus voltage of the converter 102 to a bus voltage corresponding to the delta connection (e.g., 390 V). Further, the control device 150 starts up the motor 2.

Subsequently, the control device 150 performs the driving of the motor 2 in the delta connection. Specifically, the control device 150 controls the output voltage of the inverter 1 and thereby controls the revolution speed of the motor 2. Further, the control device 150 acquires the temperature difference ΔT between the indoor temperature detected by the indoor temperature sensor 154 and the set temperature set through the remote control 155 and raises the revolution speed depending on the temperature difference ΔT up to an allowable maximum revolution speed at the maximum (130 rps in this example). By this operation, the refrigerant circulation volume of the compressor 141 is increased, the cooling capacity is raised in the case of the cooling operation, and the heating capacity is raised in the case of the heating operation.

When the indoor temperature approaches the set temperature due to the air conditioning effect and the temperature difference ΔT shows a tendency to decrease, the control device 150 decreases the revolution speed of the motor 2 depending on the temperature difference ΔT. When the temperature difference ΔT decreases to a predetermined near-zero temperature (greater than 0), the control device 150 operates the motor 2 at an allowable minimum revolution speed (20 rps in this example).

When the indoor temperature reaches the set temperature (namely, when the temperature difference ΔT decreases to 0 or less), the control device 150 stops the rotation of the motor 2 to avoid excessive cooling (or excessive heating). Accordingly, the compressor 141 shifts to the stopped state. Thereafter, when the temperature difference ΔT is greater than 0 again, the control device 150 restarts the rotation of the motor 2.

Further, the control device 150 judges whether the switching of the stator windings from the delta connection to the star connection is necessary or not. Specifically, the control device 150 judges whether or not the connection condition of the stator windings is the delta connection and the aforementioned temperature difference ΔT is less than or equal to a threshold value ΔTr. The threshold value ΔTr is a temperature difference corresponding to an air conditioning load that is low to the extent that the switching to the star connection is possible.

If the connection condition of the stator windings is the delta connection and the temperature difference ΔT is less than or equal to the threshold value ΔTr as the result of the comparison, the control device 150 outputs a stop signal to the inverter 1 and thereby stops the rotation of the motor 2. Thereafter, the control device 150 outputs a connection switching signal to the connection switching unit 160 and thereby switches the connection condition of the stator windings from the delta connection to the star connection. Subsequently, the control device 150 outputs a voltage switching signal to the converter 102, thereby lowers the bus voltage of the converter 102 to a voltage corresponding to the star connection (e.g., 280 V), and restarts the rotation of the motor 2.

In the operation in the star connection, when the temperature difference ΔT is greater than the threshold value ΔTr, the control device 150 stops the rotation of the motor 2. Thereafter, the control device 150 outputs a connection switching signal to the connection switching unit 160 and thereby switches the connection condition of the stator windings from the star connection to the delta connection. Subsequently, the control device 150 outputs a voltage switching signal to the converter 102, thereby raises the bus voltage of the converter 102 to the voltage corresponding to the delta connection (e.g., 390 V), and restarts the rotation of the motor 2.

With the delta connection, the motor 2 can be driven to higher revolution speed compared with the star connection and that makes it possible to deal with higher loads. Accordingly, the temperature difference ΔT between the indoor temperature and the set temperature can be converged in a short time.

The control device 150 stops the rotation of the motor 2 when an operation stop signal is received. Thereafter, the control device 150 switches the connection condition of the stator windings from the star connection to the delta connection. Incidentally, when the connection condition of the stator windings is already the delta connection, the connection condition is maintained.

Thereafter, the control device 150 performs a stoppage process of the air conditioner 105. Specifically, the control device 150 stops the fan motors of the indoor blower fan 147 and the outdoor blower fan 146. Thereafter, the CPU 157 of the control device 150 stops and the operation of the air conditioner 105 ends.

As above, the motor 2 is operated in the star connection of high efficiency when the temperature difference ΔT between the indoor temperature and the set temperature is relatively small (namely, less than or equal to the threshold value ΔTr). When it is necessary to deal with a higher load, namely, when the temperature difference ΔT is greater than the threshold value ΔTr, the motor 2 is operated in the delta connection capable of dealing with higher loads. Accordingly, operating efficiency of the air conditioner 105 can be increased.

Incidentally, when switching from the star connection to the delta connection, it is also possible to detect the revolution speed of the motor 2 before stopping the rotation of the motor 2 and make a judgment on whether or not the detected revolution speed is higher than or equal to a threshold value. As the threshold value for the revolution speed of the motor 2, 60 rps as the midpoint between the revolution speed 35 rps corresponding to the heating intermediate condition and the revolution speed 85 rps corresponding to the heating rated condition is used, for example. If the revolution speed of the motor 2 is higher than or equal to the threshold value, the rotation of the motor 2 is stopped, the switching to the delta connection is made, and the bus voltage of the converter 102 is raised.

By making the connection switching necessity judgment based on the revolution speed of the motor 2 as above in addition to the connection switching necessity judgment based on the temperature difference ΔT, more reliable connection switching can be carried out.

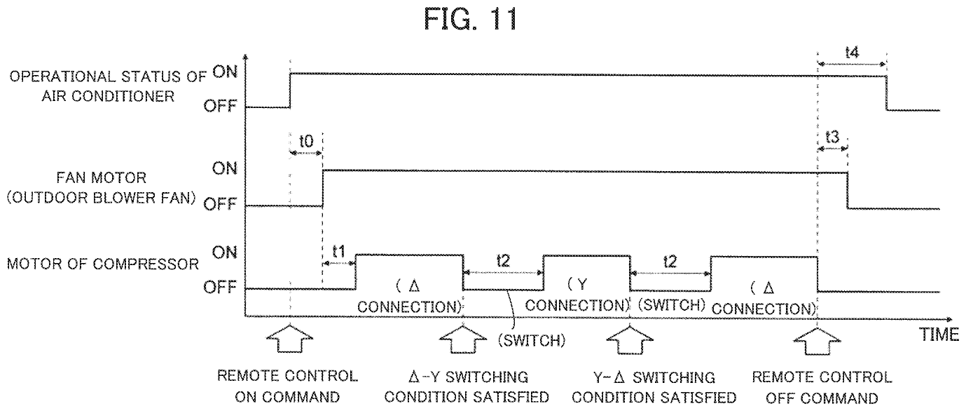

FIG. 11 is a timing chart showing an example of the operation of the air conditioner 105. FIG. 11 shows operational status of the air conditioner 105 and drive status of the outdoor blower fan 146 and the motor 2 (compressor 141). The outdoor blower fan 146 is shown as an example of a component of the air conditioner 105 other than the motor 2.

In response to an operation startup signal (ON command) received by the signal reception unit 156 from the remote control 155, the CPU 157 starts up and the air conditioner 105 shifts to a startup state (ON state). When the air conditioner 105 shifts to the startup state, the fan motor of the outdoor blower fan 146 starts rotating after the elapse of a time t0. The time t0 is a delay time due to the communication between the indoor unit 105A and the outdoor unit 105B.

Thereafter, the rotation of the motor 2 with the delta connection is started after the elapse of a time t1. The time t1 is a waiting time until the rotation of the fan motor of the outdoor blower fan 146 stabilizes. By rotating the outdoor blower fan 146 before starting the rotation of the motor 2, an excessive rise in the temperature of the refrigeration cycle is prevented.

In the example of FIG. 11, the switching from the delta connection to the star connection is made, the switching from the star connection to the delta connection is also made, and the operation stop signal (OFF command) is received from the remote control 155. The time t2 necessary for the connection switching, as a waiting time necessary for the restart of the motor 2, is set at a time necessary for the refrigerant pressure in the refrigeration cycle to become approximately uniform.

Upon receiving the operation stop signal from the remote control 155, the rotation of the motor 2 stops, and then the rotation of the fan motor of the outdoor blower fan 146 stops after the elapse of a time t3. The time t3 is a waiting time necessary for sufficiently lowering the temperature of the refrigeration cycle. After the elapse of a time t4, the CPU 157 stops and the air conditioner 105 shifts to an operation stop state (OFF state). The time t4 is a previously set waiting time.

With the air conditioner 105 according to the second embodiment, the same advantages as those of the motor driving device 100 in the first embodiment can be achieved. Namely, by using the motor 2 with the increased efficiency in the low speed (low load) region, the efficiency of the air conditioner 105 can be increased in the low speed (low load) region.

### (3) Modification

While the connection switching unit 3 has been described as mechanical switches (relays 31 to 33) in the above description of the embodiments, it is also possible to use semiconductor switches for the connection switching unit 3. By using semiconductor switches for the connection switching unit 3, connection switching (switching) at high speed can be carried out.

Further, since the operation of the motor 2 does not necessarily have to be stopped (interrupted) for the switching of the connection condition, the motor 2 can be driven with high efficiency. Especially when MOS transistors of a short switching time are used as the semiconductor switches for the connection switching unit 3 of the motor driving device 100, even switching the connection condition in the middle of the operation of the motor 2 has little influence on the motor driving device 100, and the system (e.g., the air conditioner 105) including the motor driving device 100 can be operated normally.

Incidentally, the air conditioning operation and the conditions for the switching of the connection condition described above are just an example; the conditions for the switching between the star connection and the delta connection may be determined based on various conditions such as the motor revolution speed, the motor current and the modulation factor or a combination of various conditions, for example.

1. A motor driving device for driving a motor including stator windings, comprising:
a connection switching unit that switches connection condition of the stator windings to either of first connection condition and second connection condition different from the first connection condition; and
an inverter that includes a plurality of switching elements, converts a DC voltage into AC drive voltages by on/off switching of the plurality of switching elements, and supplies the AC drive voltages to the stator windings,
wherein each of the plurality of switching elements includes a MOS transistor,
wherein the connection switching unit switches the stator windings to delta connection as the second connection condition when an absolute value of a difference between an indoor temperature and a set temperature is greater than a predetermined first temperature.

2. The motor driving device according to claim 1, wherein the plurality of switching elements include:
first and second MOS transistors connected in series between lines supplying the DC voltage;
third and fourth MOS transistors connected in series between the lines; and
fifth and sixth MOS transistors connected in series between the lines, wherein
a terminal of a first phase of the stator windings is connected to an intermediate point between the first and second MOS transistors,
a terminal of a second phase of the stator windings is connected to an intermediate point between the third and fourth MOS transistors, and
a terminal of a third phase of the stator windings is connected to an intermediate point between the fifth and sixth MOS transistors.

3. The motor driving device according to claim 2, wherein at least one of the first to sixth MOS transistors is formed of a wide band gap semiconductor.

4. The motor driving device according to claim 3, wherein the wide band gap semiconductor contains silicon carbide or gallium nitride as a constituent material.

5. (canceled)

6. The motor driving device according to claim 1, wherein the connection switching unit switches the stator windings to delta connection as the second connection condition when revolution speed of the motor is greater than or equal to a first threshold value.

7. The motor driving device according to claim 6, wherein the first threshold value is 60 rps.

8. (canceled)

9. The motor driving device according to claim 1, wherein the connection switching unit switches the stator windings to delta connection as the second connection condition when a modulation factor as a ratio of the AC drive voltage supplied to the stator windings to the DC voltage inputted to the inverter is greater than or equal to a second threshold value.

10. The motor driving device according to claim 1, wherein the connection switching unit includes a circuit including a mechanical switch connected to the stator windings.

11. The motor driving device according to claim 1, wherein the connection switching unit includes a circuit including a semiconductor switch connected to the stator windings.

12. The motor driving device according to claim 1, further comprising a control unit that controls the connection switching unit and the inverter,
wherein the control unit makes the connection switching unit perform the switching of the connection condition in a driving period of the motor or in an interruption period of the driving.

13. An air conditioner comprising:
a motor including stator windings;
a compressor driven by the motor; and
the motor driving device according to claim 1 that drives the motor.

14. A motor driving device for driving a motor including stator windings, the motor driving device being used for a compressor as part of a refrigeration cycle, the motor driving device comprising:
a connection switching unit that switches connection condition of the stator windings to either of first connection condition and second connection condition different from the first connection condition; and
an inverter that includes a plurality of switching elements, converts a DC voltage into AC drive voltages by on/off switching of the plurality of switching elements, and supplies the AC drive voltages to the stator windings,
wherein a time necessary for switching of the connection condition of the stator windings to either of first connection condition and second connection condition different from the first connection condition is a time necessary for a refrigerant pressure in the refrigeration cycle to become uniform.
